(19) United States
(12) Patent Application Publication
(10) Pub. No.: US 2011/0300475 A1
(43) Pub. Date: Dec. 8, 2011

(54) Electrophotographic Photoconductor and Image-Forming Apparatus

(75) Inventors: Kuboshima Daisuke, Osaka (JP); Shishido Makoto, Osaka (JP); Yamamoto Yohei, Osaka (JP); Shimizu Tomofumi, Osaka (JP); Miyamoto Eiichi, Osaka (JP)

(73) Assignee: KYOCERA MITA CORPORATION, Osaka (JP)

(21) Appl. No.: 13/153,123

(22) Filed: Jun. 3, 2011

(30) Foreign Application Priority Data
Jun. 4, 2010 (JP) 2010-129453

(51) Int. Cl. G03G 15/00

(52) U.S. Cl. 430/56; 399/159

(57) ABSTRACT

An electrophotographic photoconductor includes a photosensitive layer on a conductive base, in which 1) the photosensitive layer includes a charge-generating layer including a charge-generating material, and a charge-transport layer including a charge-transport material and a binder resin, the charge-generating layer and the charge-transport layer being stacked, in that order, on the conductive base, and the charge-transport layer having a yield strain of about 5%-25%, or 2) the photosensitive layer includes a charge-generating material, a charge-transport material, and a binder resin in the same layer and has a yield strain of about 5%-25%, corresponding to the yield strain measured using a 10 mm×30 mm rectangular, sample having a thickness of 30 μm with both 10-mm sides held at an initial load of 1 N, a strain rate of 0.5 %/min, and a temperature of 30°C., in which the electrophotographic photoconductor is used as an image-bearing member.

### INCORPORATED BY REFERENCE

This application is based upon and claims the benefit of priority from the corresponding Japanese Patent Applications No. 2010-129453, filed Jun. 4, 2010, the entire contents of which are incorporated herein by reference.

### FIELD

The present disclosure relates to an electrophotographic photoconductor and an image-forming apparatus including the electrophotographic photoconductor

### BACKGROUND

Electrophotographic photoconductors for use in image-forming apparatuses using electrophotographic methods include inorganic photoconductors including photosensitive layers composed of inorganic materials, such as selenium; and organic photoconductors including photosensitive layers mainly composed of organic materials, such as binder resins, charge-generating materials, and charge transport materials. Among these photoconductors, organic photoconductors are widely used because they are easily produced, materials for photosensitive layers can be selected from a wide variety of materials, and high design flexibility is provided, as compared with inorganic photoconductors.

To suppress the generation of ozone during charging in view of a longer lifetime of a photoconductor and office environment, a contact charging method is often employed as a method for charging a photoconductor instead of a method for charging a photoconductor by discharging with a charger of the related art.

Organic photoconductors have the foregoing advantages. However, organic photoconductors are likely to wear when used repeatedly because organic materials are usually composed of soft materials. For image-forming apparatuses including a charging portion, such as charging rollers, using contact charging methods, surfaces of photoconductors tend to wear more easily. With respect to image-forming apparatuses including a charging portion using contact charging methods, it is desirable to improve a wear resistance of electrophotographic photoconductors.

To improve the wear resistance of electrophotographic photoconductors composed of organic materials for use in image-forming apparatuses that include a charging portion using contact charging methods, hard materials may be used. In this case, however, sufficient wear resistance is not always provided.

### SUMMARY

According to an aspect of some embodiments of the present disclosure, an electrophotographic photoconductor includes a photosensitive layer on a conductive base, in which 1) the photosensitive layer includes a charge-generating layer including a charge-generating material, and a charge-transport layer including a charge-transport material, and a binder resin, the charge-generating layer and the charge-transport layer being stacked, in that-order, on the conductive base, and the charge-transport layer having a yield strain of about 5% to about 25%, or 2) the photosensitive layer includes the charge-generating material, the charge-transport material, and the binder resin in the same layer and has the yield strain of about 5% to about 25%, wherein the electrophotographic photoconductor is configured for use as an image-bearing member in an image-forming apparatus that includes a charging portion configured to charge a surface of the image-bearing member, an exposure portion configured to expose the charged surface of the image-bearing member to form an electrostatic latent image on the surface of the image-bearing member, a developing portion configured to develop the electrostatic latent image to form a toner image, and a transfer portion configured to transfer the toner image from the image-bearing member to an object. The charging portion may be configured to charge the surface of the image-bearing member by contact charging. The yield strain may correspond to the yield strain measured using a 10 mm×30 mm rectangular sample having a thickness of 30 μm with both 10-mm sides held at an initial load of 1 N, a strain rate of 0.5%/min, and a temperature of 30° C.

According to another aspect of some embodiments of the present disclosure, an electrophotographic photoconductor includes a photosensitive layer on a conductive base, in which 1) the photosensitive layer includes a charge-generating layer including a charge-generating material, and a charge-transport layer including a charge-transport material and a binder resin, the charge-generating layer and the charge-transport layer being stacked, in that order, on the conductive base, and the binder resin in the photosensitive layer having a yield strain of about 8% to about 30%, 2) the photosensitive layer includes the charge-generating material, the charge-transport material, and the binder resin in the same layer, the binder resin having the yield strain of about 8% to about 30%, wherein the electrophotographic photoconductor is configured for use as an image-bearing member in an image-forming apparatus, that includes a charging portion configured to charge a surface of the image-bearing member, an exposure portion configured to expose the charged surface of the image-bearing member to form an electrostatic latent image on the surface of the image-bearing member, a developing portion configured to develop the electrostatic latent image to form a toner image, and a transfer portion configured to transfer the toner image from the image-bearing member to an object. The charging portion may be configured to charge the surface of the image-bearing member by contact charging. The yield strain may correspond to the yield strain measured using a 10 mm×30 mm rectangular sample having a thickness of 30 μm with both 10-mm sides held at an initial load of 1 N, a strain, rate of 0.5%/min, and a temperature of 30° C.

According to another aspect of some embodiments the present disclosure, an image-forming apparatus includes an image-bearing member, a charging portion configured to charge a surface of the image-bearing member by a contact charging method, an exposure portion configured to expose the charged surface of the image-bearing member to form an electrostatic latent image on the surface of the image-bearing member, a developing portion configured to develop the electrostatic latent image to form a toner image, and a transfer portion configured to transfer the toner image from the image-bearing member to an object, in which the image-bearing member is any one of the electrophotographic photoconductors described above.

The above and other objects, features, and advantage of various embodiments of the present disclosure will be more apparent from the following detailed description of embodiments taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”. The phrase “an embodiment” as used herein does not necessarily refer to the same embodiment, though it may. In addition, the meaning of “a”, “an,” and “the” include plural references; thus, for example, “an embodiment” is not limited to a single embodiment but refers to one or more embodiments. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise.

Various features of novelty which characterize various aspects of the disclosure are pointed out in particularity in the claims annexed to and forming apart of this disclosure. For a better understanding of the disclosure, operating advantages and specific objects that may be attained by some of its uses, reference is made to the accompanying descriptive matter in which exemplary embodiments of the disclosure are illustrated in the accompanying drawings in which corresponding components are identified by the same reference numerals.

### BRIEF DESCRIPTION OF THE DRAWINGS

The following detailed description, given by way of example, but not intended to limit the disclosure solely to the specific embodiments described, may best be understood in conjunction with the accompanying drawings, in which:

FIGS. 1A and 1B illustrate structures of multilayer photoconductors according to some embodiments of the present disclosure;

FIGS. 2A and 2B illustrate structures of single-layer photoconductors according to some embodiments of the present disclosure;

FIG. 3 is a schematic diagram illustrating an image-forming apparatus according to an embodiment of the present disclosure;

FIG. 4 is a graph illustrating the relationship between the yield strains and the thickness change of a photosensitive layer and a binder resin of a single-layer electrophotographic photoconductor, representing some examples according to embodiments of the present disclosure; and

FIG. 5 is a graph illustrating the relationship between the yield strains and the thickness change of a photosensitive layer and a binder resin of a multilayer electrophotographic photoconductor, representing some examples according to embodiments of the present disclosure.

### DETAILED DESCRIPTION

Reference will now be made in detail to various embodiments of the disclosure, one or more examples of which are illustrated in the accompanying drawings. Each example is provided by way of explanation of the disclosure, and by no way limiting the present disclosure. In fact, it will be apparent to those skilled in the art that various modifications, combinations, additions, deletions and variations can be made in the present embodiments without departing from the scope or spirit of the present disclosure. For instance, features illustrated or described as part of one embodiment can be used in another embodiment to yield a still further embodiment. It is intended that the present disclosure covers such modifications, combinations, additions, deletions, applications and variations that come within the scope of the appended claims and their equivalents.

In an image-forming apparatus including an image-bearing member, a charging portion configured to charge a surface of the image-bearing member by a contact-charging method, an exposure portion configured to expose the charged surface of the image-bearing member to form an electrostatic latent image on the surface of the image-bearing member, a developing portion configured to develop the electrostatic latent image to form a toner image, and a transfer portion configured to transfer the toner image from the image-bearing member to an object, such as a paper, some embodiments of the present disclosure relate to an electrophotographic photoconductor that may be used as the image-bearing member. The electrophotographic photoconductor includes a photosensitive layer on a conductive base; 1) In some embodiments, the photosensitive layer includes a charge-generating layer comprising a charge-generating material, and a charge-transport layer comprising a charge-transport material and a binder resin, the charge-generating layer and the charge-transport layer being stacked, in that order, on the conductive base. 2) Alternatively, in some embodiments, the photosensitive layer includes a charge-generating material, a charge-transport material, and a binder resin in the same layer. In accordance with various embodiments, the outermost layer of the photosensitive layer and/or the binder resin in the photosensitive layer has a yield strain of a specific value.

Accordingly, electrophotographic photoconductors (hereinafter, also referred to simply as “photoconductor”) in accordance with various embodiments of the present disclosure include a single-layer type and a multilayer type. The electrophotographic photoconductor as further described below according to an embodiment of the present disclosure may be used for both types.

Note that in the specification and claims of the present disclosure, a resin included in a charge-transport layer of a multilayer photoconductor or a single-layer photoconductor is referred to as a “binder resin”. In the case where a charge-generating layer of a multilayer photoconductor includes a resin, the resin is referred to as a “base resin”. Hereinafter, a multilayer photoconductor and a single-layer photoconductor according to some embodiments will be described below.

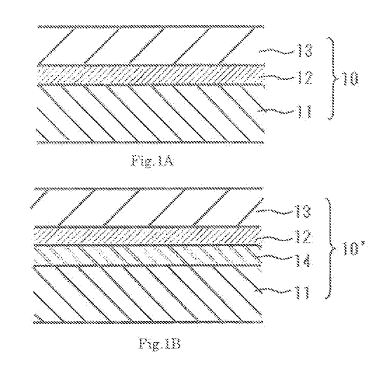

FIG. 1A illustrates an illustrative multilayer photoconductor according to some embodiments. A multilayer photoconductor 10 may be produced by forming a charge-generating layer 12 comprising a charge-generating material on a conductive base 11 by, for example, evaporation or application, applying a coating liquid including a charge-transport material and a specific binder resin onto the charge-generating layer 12, and drying the resulting coating film to form a charge-transport layer 13.

The multilayer photoconductor may be used in any of positively and negatively charging methods.

FIG. 1B illustrates another example of a multilayer photoconductor 10′ according to some embodiments. An underlying layer 14 may be formed on the conductive base 11 before the formation of the charge-generating layer. In this illustrative embodiment, the formed underlying layer 14 prevents the injection of charges from the conductive base 11 to the photosensitive layer, increases the adhesion strength between the charge-generating layer and the conductive base 11, and covers defects on a surface of the conductive base 11 to provide a smooth surface.

The conductive base and the photosensitive layer of the multilayer photoconductor according to some embodiments will be described below.

The conductive base for use in the multilayer photoconductor is not particularly limited as long as it can be used as a conductive base of the electrophotographic photoconductor.

A specific example of the conductive base according to some embodiments is a component having at least a surface comprising an electrically conductive material. For example, a component comprising an electrically conductive material may be used as the conductive base. Alternatively, a component comprising, for example, a plastic material, and having a s surface covered with an electrically conductive material may be used as the conductive base.

Examples of the electrically conductive material in accordance with some embodiments include aluminum, iron, copper, tin, platinum, silver, vanadium, molybdenum, chromium, cadmium, titanium, nickel, palladium, indium, stainless steel, and brass.

These conductive materials may be used separately or in combination as, for example, an alloy of two or more.

Among these materials, aluminum or an aluminum alloy may be preferable or particularly well-suited for implementing some embodiments of the conductive base. Such embodiments may provide a photoconductor that may be capable of forming a more preferred image in some implementations.

A possible reason for preferred images possibly being provided by some implementations of a photoconductor employing an aluminum or aluminum alloy conductive base is that, in some implementations, using such a conductive base provides for charges being satisfactorily transferred from the photosensitive layer to the conductive base.

The shape of the conductive base may be appropriately selected, depending on the structure of an image-forming apparatus used. Examples Of the shape of the base that can be used include sheets and drums.

In some embodiments, the multilayer photoconductor includes the charge-generating layer comprising the charge-generating material on the conductive base and the charge-transport layer comprising the charge-transport material and the binder resin on the charge-generating layer. The charge-generating layer may include the base resin. The binder resin, the charge-transport material, the charge-generating material, and the base resin will be described below in accordance with some embodiments.

The present inventors have thought that the use of a hard material as a binder resin would be effective in suppressing wear of an electrophotographic photoconductor. Contrary to this expectation, the present inventors have found that the use of a soft arid elastic material having a high yield strain as a photosensitive layer significantly improves wear of the electrophotographic photoconductor.

In the multilayer photoconductor according to some embodiments, the charge-transport layer has a yield strain of about 5% to about 25%. Alternatively or additionally, the binder resin included in the charge-transport layer has a yield strain of about 8% to about 30%. In the case where the charge-transport layer and/or the binder resin of the multilayer photoconductor has a yield strain falling within the above range, it is possible to suppress the wear of the charge-transport layer due to a charging portion using a contact charging method to suppress the occurrence of an image defect due to, for example, the attachment of a toner component.

With respect to an illustrative method for setting the yield strain of the charge-transport layer to about 5% to about 25%, for example, the charge-transport layer may be formed using a binder resin having a yield strain of about 8% to about 30%. Such a binder resin may be selected on the basis of the results of measurement of yield strains of resin materials used as binder resins in charge-transport layers of multilayer photoconductors, the measurement being performed according to, for example, a method described below. Furthermore, a transparent elastic material, for example, a polyester elastomer or a polyether elastomer, may be added to a binder resin having a yield strain of less than about 8% to increase the yield strain, thereby adjusting the yield strain of the charge-transport layer within the above range.

The yield strains of the charge-transport layer and the binder resin may be measured according to the method described below. It will be understood, however, that the specifics of the described method (e.g., dimensions, sampling intervals, initial load, instrumentation, etc.) may be varied; of other yield strain measurement methods maybe employed, for determining the yield strains of the charge transport layer and the binder resin. Further, it will be understood that such modified or alternative methods may provide for determining yield strains of the charge transport layer and the binder resin that may appear to deviate from the above ranges, but that actually correspond to the above ranges (i.e., the measured yield strain would be within the above ranges if measured by the following method).

The yield strain is measured with a viscoelastometer (Model: DMA Q800, manufactured by TA Instruments) at a measurement temperature of 30° C. In a 10 mm×30 mm rectangular sample having a thickness of 30 μm, both 10-mm sides are held by two clamps under an initial load of 1 N. One of the clamps is moved at a strain rate of 0.5%/min to elongate the sample. Stress is detected at sampling intervals of 2 seconds.

The relationship between the detected stress and the strain is plotted to provide a curve that represents the stress-strain relationship. A strain at which the maximum stress is obtained is determined from the resulting curve. This strain is defined as a yield strain.

Specific examples of a resin that may be used as a binder resin included in a charge-transport layer of a multilayer photoconductor according to some embodiments include thermoplastic resins, such as polycarbonate resins, styrene resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins; polyurethane resins, polyarylate resins, polysulfone resins, diallyl phthalate resins, ketone resins, and polyether resins; thermosetting resins, such as silicone resins, epoxy resins, phenol resins, urea resins, melamine resins, and other crosslinkable thermosetting resins; and photocurable resins, such as epoxy acrylate resins and urethane-acrylate copolymer resins. These resins may be used separately or in combinations of two of more:

Among these resins, polycarbonate resins, such as bisphenol Z-type polycarbonate resins, bisphenol ZC-type polycarbonate resins, bisphenol C-type polycarbonate resins, and bisphenol A-type polycarbonate resins are preferred because the photosensitive layer composed of a polycarbonate resin has excellent balance among processability, mechanical properties, optical properties, and wear resistance. In the case, for example, where the binder resin is a polycarbonate resin, the yield strain of the binder resin can be adjusted by adjusting the viscosity-average molecular weight.

The viscosity-average molecular weight [M] of a polycarbonate resin can be determined as follows: The limiting viscosity [η] is determined with an Ostwald viscometer. The viscosity-average molecular weight is calculated from Schnell's viscosity formula [η]=1.23×10⁻⁴ M^{0.83}. Note that [η] can be measured using a polycarbonate resin solution prepared by dissolving a polycarbonate resin in methylene chloride serving as a solvent in such a manner that the solution has a concentration of 6.0 g/dm³ at 20° C.

In the case, for example, where the binder resin is a polycarbonate resin, the viscosity-average molecular weight is not particularly limited as long as the charge-transport Layer and/or the binder resin exhibits a predetermined yield strain.

In some embodiments, the polycarbonate resin preferably has a viscosity-average molecular weight of 40,000 or more, from the viewpoint of achieving good wear resistance, and 80,000 of less, from the viewpoint of achieving good coatability, and particularly 50,000 to 78,000 may be preferable in some implementations.

The charge-transport material is not particularly limited as long as it can be used as a charge-transport material included in the photosensitive layer of the electrophotographic photoconductor. In general, charge-transport materials include hole-transport materials and electron-transport materials.

Specific examples of a hole-transport material according to some embodiments include benzidine derivatives; oxadiazole compounds, such as 2,5-di-(4-methylaminophenyl)-1,3,4-oxadiazole; styryl compounds, such as 9-(4-diethylaminostyryl)anthracene; carbazole compounds, such as polyvinylcarbazole; organic polysilane compounds; pyrazoline compounds, such as 1-phenyl-3-(p-dimethylaminophenyl)pyrazoline; hydrazone compounds; triphenylamine compounds; nitrogen-containing cyclic compounds, such as indole compounds, oxazole compounds, isoxazole compounds, thiazole compounds, and triazole compounds; and fused polycyclic compounds. Among these hole-transport materials, triphenylamine compounds, each having one or more triphenylamine skeletons in a molecule, are preferred. These hole-transport materials may be used separately or in combination of two or more.

Specific examples of an electron-transport material according to some embodiments include quinone derivatives, such as naphthoquinone derivatives, diphenoquinone derivatives, anthraquinone derivatives, azoquinone derivatives, nitroanthraquinone derivatives, and dinitroanthraquinone derivatives; and malononitrile derivatives, thiopyran derivatives, trinitrothioxanthone derivatives, 3,4,5,7-tetranitro-9-fluorenone derivatives, dinitroanthracene derivatives, dinitroacridine derivatives, tetracyanoethylene, 2,4,8-trinitrothioxanthone, dinitrobenzene, dinitroanthracene, dinitroacridine, succinic anhydride, maleic anhydride, and dibromomaleic anhydride. These electron-transport materials may be used separately or in combination of two or more.

The charge-generating material is not particularly limited as long as it can be used as a charge-generating material for the electrophotographic photoconductor. Specific examples thereof according to some embodiments include X-form metal-free phthalocyanine (x-H2Pc) represented by formula (1) described below, Y-form oxotitanylphthalocyanine (Y-TiOPc), perylene pigments, biszo pigments, dithioketopyrrolopyrrole pigments, metal-free naphthalocyanine pigments, metal naphthalocyanine pigments, squaraine pigments, trisazo pigments, indigo pigments, azulenium pigments, cyanine pigments, powdered inorganic photoconductive materials, such as selenium, selenium-tellurium, selenium-arsenic, cadmium sulfide, and amorphous silicon, pyrylium salts, anthanthrone pigments, triphenylmethane pigments, indanthrene pigments, toluidine pigments, pyrazoline pigments, and quinacroidone pigments.

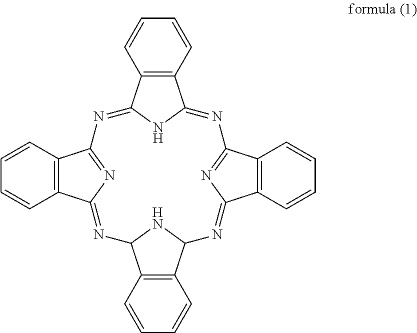

These charge-generating materials may be used separately or in combination of two or more so as to have an absorption wavelength in a desired region. Among these charge-generating materials, in particular, for digital optical image-forming apparatuses, such as laser beam printers and facsimiles, provided with light sources, such as semiconductor lasers, photoconductors sensitive in the wavelength range of 700 nm or more are required. So, for. example, phthalocyanine pigments, such as metal-free phthalocyanine and oxotitanylphthalocyanine, are used in some embodiments.

Note that various crystal forms of the phthalocyanine pigments may be used without limitation. Furthermore, for analog optical image-forming apparatuses, such as electrostatic copiers, provided with white lights sources, such as halogen lamps, photoconductors sensitive in the visible range are required. So, for example, perylene pigments and bisazo pigments are used in some such implementations.

In the case where a solution containing the charge-generating material is applied onto the conductive base to form the charge-generating layer, the base resin is used together with the charge-generating material. A resin different from the binder resin used in the same photoconductor is selected as the base resin so as not to dissolve in a solvent for use in a solution to form the charge-transport layer because the charge-generating layer and the charge-transport layer are usually stacked in that order. Examples of the base resin in accordance with some embodiments include styrene-butadiene copolymers, styrene-acrylonitrile copolymers, styrene-maleic acid copolymers, acrylic copolymers, styrene-acrylic acid copolymers, polyethylene resins, ethylene-vinyl acetate copolymers, chlorinated polyethylene resins, polyvinyl chloride resins, polypropylene resins, ionomer resins, vinyl chloride-vinyl acetate copolymers, alkyd resins, polyamide resins, polyurethane resins, polysulfone resins, diallyl phthalate resins, ketone resins, polyvinyl acetal resins, polyvinyl butyral resins, polyether resins, silicone resins, epoxy resins, phenolic resins, urea resins, melamine resins, epoxy acrylate resins, and urethane-acrylate resins. These base resins for use in the charge-generating layer may be used separately or in combination of two or more.

In accordance with some embodiments, the photosensitive layer of the multilayer photoconductor is formed by stacking the charge-generating layer and the charge-transport layer on the conductive base or on an underlying layer formed on the conductive base.

By way of example, the charge-generating layer of the multilayer photoconductor may have a thickness of 0.1 μm to 5 μm in some embodiments and more preferably 0.1 μm to 3 μm in some implemenations. In some embodiments, the charge-transport layer may have a thickness of 2 μm to 100 μm and more preferably 5 μm to 50 μm.

The charge-generating material amount of the charge-generating layer is not particularly limited as long as the desired characteristics of the photoconductor are achieved. In some embodiments, in the case where the charge-generating layer is formed by applying a coating liquid, the amount of the charge-generating material is preferably in the range of 10 parts by mass to 500 parts by mass and more preferably 30 parts by mass to 300 parts by mass with respect to 100 parts by mass of the base resin.

In some embodiments, the charge-transport layer preferably has a charge-transport material less than amount of 55 parts by mass, more preferably 5 parts mass to 55 parts by mass, and particularly preferably 10 parts by mass to 55 parts by mass with respect to 100 parts by mass of the binder resin. Note that the amount of the charge-transport material is the total amount of the hole-transport material and the electron-transport material in the charge-transport layer. In accordance with some embodiments, when the amount of the charge-transport material falls within the above range, the multilayer photoconductor having excellent wear resistance is easily provided.

Some examples of a method for forming a charge-generated layer include vacuum evaporation of a charge-generating material and the application of a coating liquid containing a charge-generating material, a base resin, and a solvent. As a method for forming the charge-generating layer, the application of the coating liquid including a charge-generating material, a base resin, and a solvent may be preferred because it does not require an expensive evaporation apparatus and it provides for an easy film-forming operation. An example of a method for forming a charge-transport layer is the application of a coating liquid including a charge-transport material, a binder resin, and a solvent.

In accordance with some embodiments, with respect to a solvent used to prepare a coating liquid for forming a photosensitive layer, various organic solvents that have traditionally been used for coating liquids for forming photosensitive layers may be used, provided that they do not dissolve a layer which has been formed by application.

Examples of the solvent according to some embodiments include alcohols, such as methanol, ethanol, isopropanol, and butanol; aliphatic hydrocarbons, such as n-hexane, octane, and cyclohexane; aromatic hydrocarbons, such as benzene, toluene, and xylene; halogenated hydrocarbons, such as dichloromethane, dichloroethane, chloroform, carbon tetrachloride, and chlorobenzene; ethers, such as dimethyl ether, diethyl ether, tetrahydrofuran, dioxane, dioxolane, ethylene glycol dimethyl ether, and diethylene glycol dimethyl ether; ketones, such as acetone, methyl ethyl ketone, methyl isobutyl ketone, and cydohexanone; esters, such as ethyl acetate and methyl acetate; and aprotic polar organic solvents, such as N,N-dimethylformaldehyde, N,N-dimethylformamide, and dimethyl sulfoxide.

The coating liquid for forming the charge-generating layer or the charge-transport layer may include various known additives to the extent that electrophotographic characteristics are not adversely affected to an extent such that the desired characteristics of the photoconductor are not achieved. Examples of additives that may be included in the coating liquid according to some embodiments include antidegradants, such as antioxidants, radical scavengers, singlet quenchers, and ultraviolet absorbers, softeners, plasticizers, surface modifiers, extenders, thickeners, dispersion stabilizers, wax, acceptors, and donors. Furthermore, to improve the dispersibility of the charge-transport material and the charge-generating material and the smoothness of a surface of the photosensitive layer, a surfactant and a leveling agent may be used.

A method for applying the coating liquid for forming the charge-generating layer or the charge-transport layer is not particularly limited. Some examples thereof include methods using spin coaters, applicators, spray coaters, bar coaters, dip coaters, and doctor blades.

A coating film formed by applying the coating liquid using the foregoing method is dried with, for example a high-temperature dryer of a vacuum dryer to remove the solvent, thereby providing a charge-generating layer or a charge-transport layer. In some embodiments, the drying temperature may be in the range of 40° C. to 150° C. In such embodiments, when the coating film is dried in this temperature range, the removal of the solvent proceeds successfully, thereby efficiently forming the charge-generating layer or the charge-transport layer having a uniform thickness. An excessively high drying temperature is usually not preferred because materials in the photosensitive layer can be thermally decomposed.

The underlying layer may be formed by preparing a coating liquid including a resin,-inorganic fine particles, such as zinc oxide or titanium oxide particles, and a solvent, applying the coating liquid onto a conductive base, and drying the applied coating liquid.

In accordance with some embodiments the electrophotographic photoconductor may be implemented as a single-layer photoconductor. As understood by those skilled in the art, a single-layer photoconductor as used herein refers to a photoconductor in which the charge-generating and charge-transport functions are provided in the same layer, although the photoconductor may comprise two or more layers. In accordance with some embodiments, a single-layer photoconductor may be preferable to a multilayer photoconductor. Reasons for this preference in some cases include the following: the photoconductor is easily produced and has excellent optical properties owing to a small number of interfaces between layers because the photosensitive layer is a single layer.

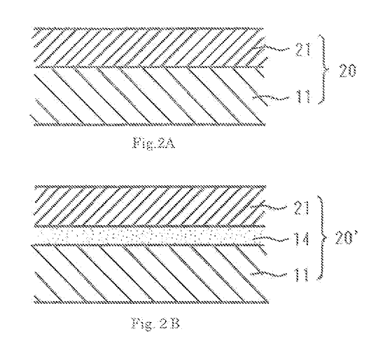

FIG. 2A illustrates an example of a single-layer photoconductor according to some embodiments. In the illustrated embodiment, a single layer photoconductor 20 includes a single photosensitive layer 21 on the conductive base 11. The photosensitive layer of the single-layer photoconductor may be formed as follows. For example, a coating liquid is prepared by dissolving or dispersing a charge-transport material, a charge-generating material, a binder resin and optionally leveling agent and so forth in an appropriate solvent. The resulting coating liquid is applied onto the conductive base 11 and the applied coating liquid is dried, thereby forming the photosensitive layer.

FIG. 2B illustrates another example of a single-layer photoconductor 20′. In this embodiment, the photosensitive layer 21 is formed on the conductive base 11 with the underlying layer 14 provided therebetween.

The conductive base and the photosensitive layer of the single-layer photoconductor according to some embodiments will be described below.

A base comprising one or more materials the same as described hereinabove for the conductive base used in the multilayer photoconductor may be used as a conductive base for use in the single-layer photoconductor. The shape of the conductive base may be appropriately selected, depending on the structure of an image-forming apparatus used. Examples of the shape of the base that can be used include sheets and drums.

Materials included in the photosensitive layer of the single-layer photoconductor according to some embodiments include a binder resin, a charge-transport material, and a charge-generating material. The charge-transport material and the charge-generating material included in the photosensitive layer of the single-layer photoconductor may be the same as those of the multilayer photoconductor.

In accordance with some embodiments, in the single-layer photoconductor, the photosensitive layer has a yield strain of about 5% to about 25%. Alternatively or additionally, the binder resin included in the photosensitive layer has a yield strain of about 8% to about 30%. With respect to a method for setting the yield strain of the photosensitive layer to the range of about 5% to about 25% or a method for setting the yield strain of the binder resin included in the photosensitive layer to the range of about 8% to about 30%, a method similar to the above described method for setting the yield strain of the charge-transport layer of the multilayer photoconductor may be employed.

In the case where the photosensitive layer and/or the binder resin has a yield strain falling within the above range, it is less likely to cause the wear of the photosensitive layer due to a charging portion using a contact charging method and an image defect due to, for example, the attachment of a toner component.

In some embodiments, a resin the same as the binder resin for use in the charge-transport layer of the-multilayer photoconductor may be used as the binder resin included in the photosensitive layer of the single-layer photoconductor.

The photosensitive layer of the single-layer photoconductor may be formed as follows: A coating liquid comprising a charge-transport material, a charge-generating material, a binder resin, and a solvent is prepared. The photosensitive layer may be formed by a method similar to the method for forming the charge-generating layer or the charge-transport layer of the multilayer photoconductor.

In some embodiments, the amount of the charge-transport material used in the photosensitive layer of the single-layer photoconductor is preferably in the range of 55 parts by mass or less, more preferably 5 parts by mass to 55 parts by mass, and particularly preferably 10parts by mass to 55 parts by mass with respect to 100 parts by mass of the binder resin. Note that the amount of the charge-transport material is the total amount of the hole-transport material and the electron-transport material in the photosensitive layer. In accordance with some embodiments, when the amount of the charge-transport material falls within the above range, the single-layer photoconductor having excellent wear resistance is easily provided.

In some embodiments, the amount of the charge-generating material used in the photosensitive layer of the single-layer photoconductor is preferably in the range of 0.2 parts by mass to 40 parts by mass and more preferably 0.5 parts by mass to 20 parts by mass with respect to 100 parts by mass of the binder resin. In accordance with some embodiments, when the amount of the charge-generating material used falls within the above range, it is possible to produce the photoconductor having excellent electrical properties without causing a reduction in the wear resistance of the photoconductor.

The thickness of the photosensitive layer of the single-layer photoconductor is not particularly limited as long as the photosensitive layer has a suitable function as a photosensitive layer. Specifically, for example, in some embodiments the photosensitive layer preferably has a thickness of 5 μm to 100 μm and more preferably 10 μm to 50 μm.

Some embodiments of the present disclosure also relate to an image-forming apparatus that includes an image-bearing member, a charging portion configured to charge a surface of the image-bearing member by a contact charging method, an exposure portion configured to expose the charged surface of the image-bearing member to form an electrostatic latent image on the surface of the image-bearing member, a developing portion configured to develop electrostatic latent image to form a toner image, and a transfer portion configured to transfer the toner image from the image-bearing member to an object, such as a paper, in which the electrophotographic photoconductor according to the foregoing discussed embodiments is used as the image-bearing member.

The image-forming apparatus according to this embodiment of the present disclosure can be used for any of monochrome-image-forming apparatuses and color-image-forming apparatuses. Here a tandem-type color image-forming apparatus using a plurality of color toners will be described.

The image-forming apparatus provided with the electrophotographic photoconductor according to such embodiments may include a plurality of image-bearing members which are juxtaposed to each other in a predetermined direction and which are configured to form toner images using toners of different colors; and a plurality of developing portions including developing rollers which face the respective image-bearing members and which are configured to transfer the toners attached on surfaces thereof and feed the toners onto surfaces of the respective image-bearing members, in which the electrophotographic photoconductor according to the foregoing discussed embodiment is used as each of the image-bearing members.

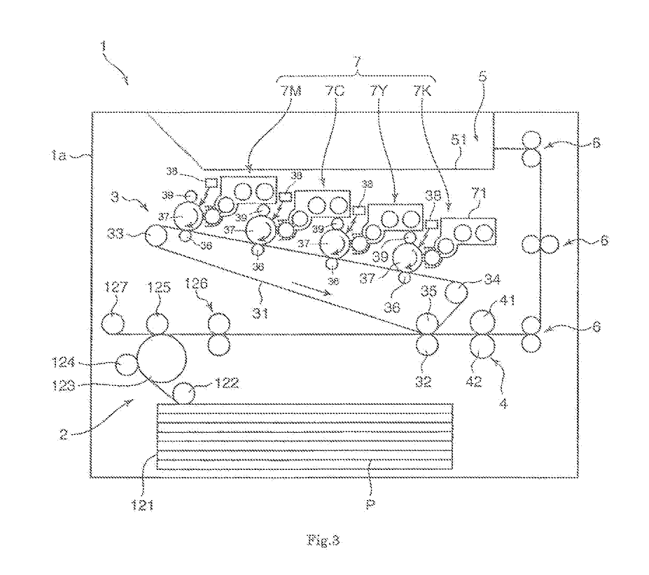

FIG. 3 is a schematic diagram illustrating an embodiment of a tandem-type color-image-forming apparatus including an electrophotographic photoconductor according to the foregoing discussed embodiments of the present disclosure.

Here, the image-forming apparatus will be described by taking a color printer 1 as an example.

As illustrated in FIG. 3, the color printer 1 includes a box-shaped main body 1a. The box-shaped main body 1a is provided with a paper feed portion 2 configured to feed paper P, an image-forming portion 3 configured to transfer a toner image on the paper P on the basis of, for example, image data while the paper P fed from the paper feed portion 2 is being transferred, and a fusing portion 4 configured to perform fusing treatment in which the unfused toner image transferred on the paper P in the image-forming unit 3 is fused on the paper P. Furthermore, a paper-ejecting portion 5 to which the paper P subjected to the fusing treatment in the fusing portion 4 is ejected is arranged on the upper surface of the main body 1a.

The paper feed portion 2 includes a paper feed cassette 121, a pick-up roller 122, paper feed rollers 123, 124, and 125, and a registration roller 126.

The paper feed cassette 121 configured to store different sized sheets of paper P is detachably arranged in the main body 1a. The pickup roller 122 arranged at the upper left of the paper feed cassette 121 as illustrated in FIG. 3 and picks up the paper P, sheet by sheet, stored in the paper feed cassette 121.

The paper feed rollers 123, 124, and 125 feed the paper P picked up by the pickup roller 122 to a paper conveying path. The registration roller 126 temporarily holds the paper P fed by the paper feed rollers 123, 124, and 125 to the paper conveying path, and then feeds the paper P to the image-forming portion 3 at a predetermined time.

The paper feed portion 2 further includes a manual feed tray (not shown) attached to the left side of the main body 1a illustrated in FIG. 3; and a pickup roller 127. The pickup roller 127 picks up the paper P placed in the manual feed tray.

The paper P picked up by the pickup roller 127 is fed by the paper feed rollers 123 and 125 to the paper conveying path and then fed by the registration roller 126 to the image-forming portion 3 at a predetermined time.

The image-forming portion 3 includes an image-forming unit 7, an intermediate transfer belt 31 of which a toner image formed on the basis of image data transmitted from, for example, a computer is primarily transferred by the image-forming unit 7 onto a surface (contact surface), and a secondary transfer roller 32 configured to secondarily transfer the toner image formed on the intermediate transfer belt 31 onto the paper P fed from the paper feed cassette 121.

The image-forming unit 7 includes a unit 7K for a black toner development, a unit 7Y for yellow toner development, a unit 7C for cyan toner development, and a unit 7M for magenta toner development sequentially arranged from the upstream side (right side in FIG. 3) to the downstream side.

A drum-shaped electrophotographic photoconductor 37 serving as an image-bearing member is arranged at the center of each of the units 7K, 7Y, 7C, and 7M so as to be rotated in the direction indicated by an arrow (in a clockwise direction).

A charging portion 39, an exposure portion 38, a developing portion 71, a cleaning portion (not shown), a charge eliminator (not shown) as a charge eliminating portion, and so forth are arranged around each of the photoconductors 37 from the upstream side along the rotational direction. As the photoconductor 37, a multilayer or a single-layer photoconductor according to the hereinabove described embodiments is used.

The charging portion 39 uniformly charges the circumferential face of the electrophotographic photoconductor 37 that rotates in the direction indicated by the arrow. A specific example of the charging portion 39 is a portion in which a charging roller or a charging brush charges the circumferential face (surface) of the photoconductor 37 while the section is in contact with the photoconductor 37. The charging portion 39 including the charging roller is preferably used in various embodiments.

The image-forming apparatus according to embodiments of the present disclosure includes an electrophotographic photoconductor having excellent wear resistance. It is thus possible to employ a contact charging method using, for example, a charging roller as the charging portion 39. The use of the charging portion 39 employing the contact method suppresses the emission of active gases, such as ozone and nitrogen oxides, generated from the charging portion 39, prevents the degradation of the photosensitive layer of the electrographic photoconductor due to the active gases, and enables the design of an image-forming apparatus in view of office environments and so forth.

In the case where the charging portion 39 includes a charging roller using a contact charging method, the charging roller is not particularly limited as long as the charging roller is capable of charging the circumferential face of the electrophotographic 37 while in contact with the electrophotographic photoconductor 37.

An example of the charging roller is a roller that is driven by the rotation of the electrophotographic photoconductor 37 while the roller is in contact with the electrophotographic photoconductor 37. A roller having at least a surface-portion composed of a resin is exemplified.

More specifically, a charging roller is exemplified which includes a mandrel rotatably supported, a resin layer arranged on the mandrel, and a voltage-applying potion configured to apply a voltage to the mandrel. The charging portion including the charging roller charges the surface of the electrophotographic photoconductor 37 in contact with the resin layer by the application of a voltage to the mandrel using the voltage-applying portion.

A resin used for the resin layer of the charging roller is not particularly limited as long as it can satisfactorily charge the circumferential face of the electrophotographic photoconductor 37.

Specific examples of the resin used for the resin layer according to some embodiments include silicone resins, urethane resins, and silicone-modified resins. The resin layer may include an inorganic filler.

In various embodiments such as that presently described, a voltage applied by the voltage-applying portion to the charging roller is preferably only a direct voltage. In some embodiments, the direct voltage applied by the charging roller to the electrophotographic photoconductor may preferably be in the range of 1000 V to 2000 V, more preferably 1200 V to 1800 V, and particularly preferably 1400 V to 1600 V. When only a direct voltage applied to the charging roller, the wear amount of the photosensitive layer tends to be small, compared with the case where an alternating voltage or a superimposed voltage in which an alternating voltage is superimposed on a direct voltage is applied to the charging roller.

Thus, the application of only a direct voltage to the charging roller results in the formation of a suitable image while also providing for a reduction in the wear amount of the photosensitive layer (compared with the case where an alternating voltage of a superimposed voltage is used).

The exposure portion 38 is what is called a laser scanning portion configured to irradiate the circumferential face of the electrophotographic photoconductor 37 uniformly charged by the charging portion 39 with laser light on the basis of image data input from a personal computer (PC), which is a host system, to form an electrostatic latent image on the electrophotographic photoconductor 37.

The developing portion 71 feeds a toner onto the circumferential face of the electrophotographic photoconductor 37 on which the electrostatic latent image has been formed, thereby forming a toner image on the basis of the image data. The resulting toner image is primarily transferred to the intermediate transfer belt 31.

The cleaning portion removes the remaining toner on the circumferential face of the electrophotographic photoconductor 37 after the primary transfer of the toner image to the intermediate transfer belt 31.

The charge eliminator eliminates the charge on the circumferential face of the electrophotographic photoconductor 37 after the completion of the primary transfer. The circumferential face of the electrophotographic photoconductor 37 that has been subjected to cleaning by the cleaning portion and neutralizing the charge eliminator rotates the charging portion for next charging treatment and is then subjected to another charging treatment in the charging portion.

The intermediate transfer belt 31 is an endless belt that is stretched over plural rollers, such as a driving roller 33, a driven roller 34, a backup roller 35, and primary transfer rollers 36, in such a manner that a surface (contact surface) of the intermediate transfer belt 31 is in contact with the circumferential face of each of the electrophotographic photoconductors 37.

The intermediate transfer belt 31 is configured to run endlessly over the plural rollers while the intermediate transfer belt 31 is pressed against the electrophotographic photoconductors 37 by the primary transfer rollers 36 that face the respective photoconductors 37.

The driving roller 33 is rotationally powered by a driving source, such as a stepping motor, and provides a driving force to cause the intermediate transfer belt 31 to run endlessly. The driven roller 34, the backup roller 35, and the primary transfer rollers 36 are rotatably arranged and are rotationally driven by the driving roller 33 via the endless run of the intermediate transfer belt 31. These rollers 34, 35, arid 36 are rotationally driven fry the rotation of the driving roller 33 via the intermediate transfer belt 31 and support the intermediate transfer belt 31.

The primary transfer rollers 36 apply primary transfer biases (a polarity opposite to a charge polarity of toners) to the intermediate transfer belt 31. The toner images formed on the photoconductors 37 are sequentially transferred (primarily transferred)to the intermediate transfer belt 31 in a superposition manner at positions between the photoconductors 37 and the respective primary transfer rollers 36, the intermediate transfer belt 31 running in the direction indicated by the arrow (counterclockwise) by the driving of the driving roller 33.

The secondary transfer roller 32 applies a secondary transfer bias, which has a polarity opposite to that of the toner image, to the sheet P. The toner image primarily transferred to the intermediate transfer belt 31 is transferred to the sheet P at a position between the secondary transfer roller 32 and the backup roller 35, thereby transferring a color transfer image (unfused toner image) on the paper P.

The fusing portion 4 is configured to subjecting the transfer image transferred to the paper P in the image-forming portion 3 to fusing treatment. The fusing portion 4 includes a heating roller 41 heated by an electric heating member and a pressing roller 42 which faces the heating roller 41 and which has a circumferential face that is pressed against the circumferential face of the heating roller 41. The transfer image transferred to the paper P by the secondary transfer roller 32 in the image-forming portion 3 is subjected to fusing treatment by heating when the paper P is passed between the heating roller 41 and the pressing roller 42, thereby fusing the image on the paper P.

The fused paper P is ejected to the paper ejecting portion 5.

In the color printer 1 according to this illustrative embodiment, conveying rollers 6 are appropriately arranged between the fusing portion 4 and the paper-ejecting portion 5.

The paper-ejecting portion 5 is a recessed portion located on the top of the main body 1a of the color printer 1. A paper output tray 51 configured to receive the ejected paper P is arranged on the bottom of the recessed portion.

The color printer 1 forms an image on the paper P by the foregoing image-forming operations. Such a tandem-type image-forming apparatus described above includes the electrophotographic photoconductor according to the hereinabove embodiments (e.g., a single-layer photoconductor or a multilayer photoconductor) as an image-bearing member. Accordingly, embodiments of the image-forming apparatus include the highly durable photosensitive layer, in which the wear amount of the photosensitive layer is small, and such embodiments of the image-forming apparatus are capable of forming a suitable image even when the charging portion using the contact charging method is arranged therein.

### EXAMPLES

While the present disclosure will be described in detail below by examples, the present disclosure and the claimed subject matter are not limited to or by the examples.

First, a single-layer electrophotographic photoconductor according to some embodiments was tested.

### Example 1

Metal-free phthalocyanine (5 parts by mass),a hole-transport material (HTM-1) of the following formula (50 parts by mass), an electron-transport material(ETM-1) of formula (35 parts by mass) bisphenol Z-type polycarbonate resin with a viscosity average molecular weight of 75,000 (100 parts by mass), and tetrahydrofuran (800 parts by mass) were charged into a ball mill. The mixture was subjected to dispersion treatment for 50 hours to prepare a coating liquid for a photosensitive layer. The resulting coating liquid was applied by dip coating onto a conductive base, which was a cylindrical aluminum tube haying a diameter of 30 mm, and dried at 100° C. for 40 minutes to remove tetrahydrofuran from the resulting coating film, thereby providing a positively charging single-layer electrophotographic photoconductor having a photosensitive layer having a thickness of 30 μm:

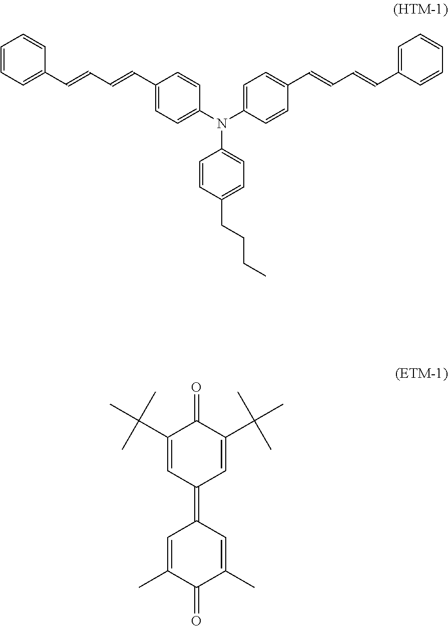

### Examples 2 and 3 and Comparative Examples 1 to 3

Positively charging single-layer electrophotographic photoconductors were produced as in Example 1, except that resins described in Table 1 were used in place of the binder resin. In Table 1, PC-Z represents a bisphenol Z-type polycarbonate resin, PC-C represents a bisphenol C-type polycarbonate resin, and PC-C/PC-Z represents a polycarbonate copolymer of bisphenol Z and bisphenol C at a molar ratio of 1:1.

Each of the single-layer electrophotographic photoconductors produced in Examples 1 to 3 and Comparative Examples 1 to 3 was attached to a printer (Model: FS-1300D, manufactured by KYOCERA MITA Corporation) including a charging roller configured to apply a direct voltage. After performing a printing test of 50,000 sheets, an image and a change in the thickness of the photosensitive layer were evaluated. Table 1 shows the evaluation results of the image and the thickness change.

TABLE 1

| | Binder resin | | | | Evaluation | |
|---|---|---|---|---|---|---|
| | | Viscosity- | | | Amount of | |
| | | average | Yield strain (%) | | thickness | |
| | | molecular | Photosensitive | Binder | change | |
| | Type | weight | layer | resin | (μm) | Image |
| Example 1 | PC-Z | 75000 | 23.0 | 29.0 | 3.25 | Good |
| Example 2 | PC-Z | 67000 | 14.0 | 20.0 | 3.10 | Good |
| Example 3 | PC-C/ | 55000 | 7.10 | 9.0 | 3.52 | Good |
| | PC-Z | | | | | |
| Comparative | PC-Z | 30000 | 2.94 | 7.3 | 4.56 | Good |
| Example 1 | | | | | | |
| Comparative | PC-C | 48000 | 2.40 | 5.0 | 7.48 | Good |
| Example 2 | | | | | | |
| Comparative | PC-Z | 80000 | 27 | 32 | 2.40 | Poor |
| Example 3 | | | | | | |

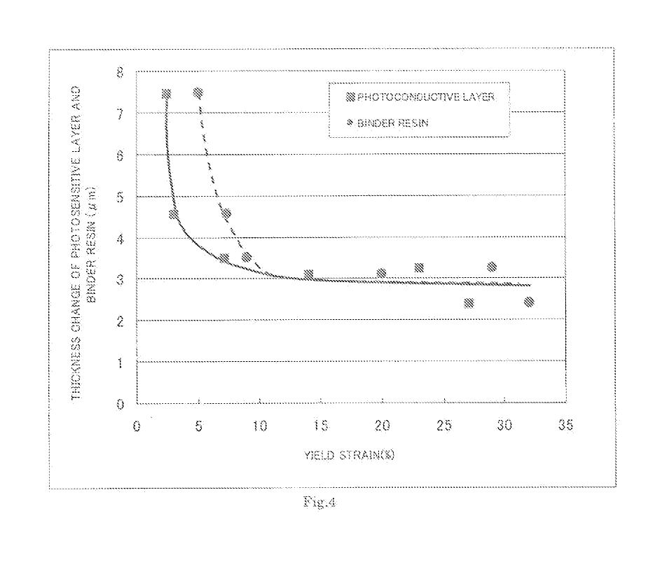

The relationship between the yield strain and the thickness change of the photosensitive layer and a binder resin of the single-layer electrophotographic photoconductor is plotted in graph form on the basis of data obtained in Examples 1 to 3 and Comparative Examples 1 to 3 and is illustrated in FIG. 4.

FIG. 4 demonstrates that a yield strain of the photosensitive layer of less than about 5% results in a significant increase in the amount of thickness change and that a yield strain of the binder resin of less than about 8% results in a significant increase in the amount of thickness change.

The results of Examples 1 to 3 demonstrate that a yield strain of the photosensitive layer of about 5% to about 25% or a yield strain of the binder resin of about 8% to about 30% results in the single-layer electrophotographic photoconductor exhibiting only a small amount of thickness change and having excellent wear resistance and being less likely to have an image defect such as due to the attachment of, for example, a toner component to the single-layer electrophotographic photoconductor.

In the single-layer electrophotographic photoconductor produced in each of Comparative Examples 1 and 2 in which the photosensitive layers each had a yield strain of less than about 5% and in which the binder resins each had a yield strain of less than about 8%, there is no image defect due to the attachment of, for example, a toner component to a surface of the single-layer electrophotographic photoconductor. However, the amount of thickness change was large. So, the photoconductor had poor wear resistance.

In the single-layer electrophotographic photoconductor produced in Comparative Example 3 in which the photosensitive layer had a yield strain exceeding about 25% and in which the binder resin had a yield strain exceeding about 30%, the amount of thickness change was small. So, the photoconductor had excellent wear resistance. However, an image defect Occurred. The reason for the occurrence of the image defect is presumably that the toner component or the like attached to the surface of the photosensitive layer was not removed by the wear of the surface of the photosensitive layer because of a small amount of thickness change of the photosensitive layer of the single-layer electrophotographic photoconductor.

Next, a multilayer electrophotographic photoconductor according to some embodiments was tested.

### Example 4

Titanium oxide particles (SMT-A (trial product), number-average primary particle size: 10 nm, manufactured by Tayca Corporation) (2.8 parts by mass), which was prepared by surface treatment with alumina and silica and then with methylhydrogenpolysiloxane by a wet dispersion process, and a copolymer polyamide resin (DIAMID X4685, manufactured by Daicel-Degussa Ltd.) (1 part by mass) were added to a mixed solvent of ethanol (10 parts by mass) and butanol (2 parts by mass). The resulting mixture was subjected to dispersion treatment with a bead mill for 5 hours, thereby preparing a coating liquid for forming an underlying layer.

The coating liquid for forming an underlying layer was applied onto a conductive base by dip coating. After the application of the coating liquid, the resulting coating film was treated at 100° C. for 30 minutes, thereby forming a 1.5-μm-thick underlying layer on the conductive base.

Titanylphthalocyanine (charge-generating material) (1 part by mass) and a polyvinyl butyral resin (base resin, Denka Butyral #6000C, manufactured by Denki Kagaku Kogyo Kabushiki Kaisha) (1 part by mass) were mixed with a mixed dispersion medium of propylene glycol monomethyl ether (40 parts by mass) and tetrahydrofuran (40 parts by mass). The resulting mixture was subjected to dispersion treatment with bead mill for 2 hours, thereby preparing a coating liquid for forming a charge-generating layer. The coating liquid for forming a charge-generating layer was applied onto the underlying layer by dip coating. After the application of the coating liquid, the resulting coating film was treated at 50° C. for 5 minutes to form a charge-generating layer having a thickness of 0.3 μm.

A hole-transport material (HTM-1) (40 parts by mass) and a bisphenol Z-type polycarbonate resin (100 parts by mass) having a viscosity-average molecular weight of 75,000were dissolved in a mixed solvent of tetrahydrofuran (430 parts by mass) and toluene (430 parts by mass) to prepare a coating liquid for forming a charge-transport layer.

The resulting coating liquid for forming a charge-transport layer was applied onto the charge-generating layer in the same way as the charge-generating layer. The resulting coating film was dried at 130° C. for 30 minutes to form a charge-transport layer having a thickness of 20 μm.

### Examples 5 and 6 and Comparative Examples 4 and 5

Multilayer electrophotographic photoconductors were produced as in Example 4, except that resins described in Table 2 were used in place of the binder resin.

Each of the multilayer electrophotographic photoconductors produced in Examples 4 to 6 and Comparative Examples 4 and 5 was attached to a commercially available printer which employed a negative-charging reversal development process and which included a charging roller. After performing a printing test of 30,000 sheets, a change in the thickness of the photosensitive layer was evaluated. Table 2 shows the evaluation results of the change in thickness.

TABLE 2

| | Binder resin | | | | Evaluation | |
|---|---|---|---|---|---|---|
| | | Viscosity- | | | Amount of | |
| | | average | Yield strain (%) | | thickness | |
| | | molecular | Photosensitive | Binder | change | |
| | Type | weight | layer | resin | (μm) | Image |
| Example 1 | PC-Z | 75000 | 23.0 | 29.0 | 3.25 | Good |
| Example 2 | PC-Z | 67000 | 14.0 | 20.0 | 3.10 | Good |
| Example 3 | PC-C/ | 55000 | 7.10 | 9.0 | 3.52 | Good |
| | PC-Z | | | | | |
| Comparative | PC-Z | 30000 | 2.94 | 7.3 | 4.56 | Good |
| Example 1 | | | | | | |
| Comparative | PC-C | 48000 | 2.40 | 5.0 | 7.48 | Good |
| Example 2 | | | | | | |
| Comparative | PC-Z | 80000 | 27 | 32 | 2.40 | Poor |
| Example 3 | | | | | | |

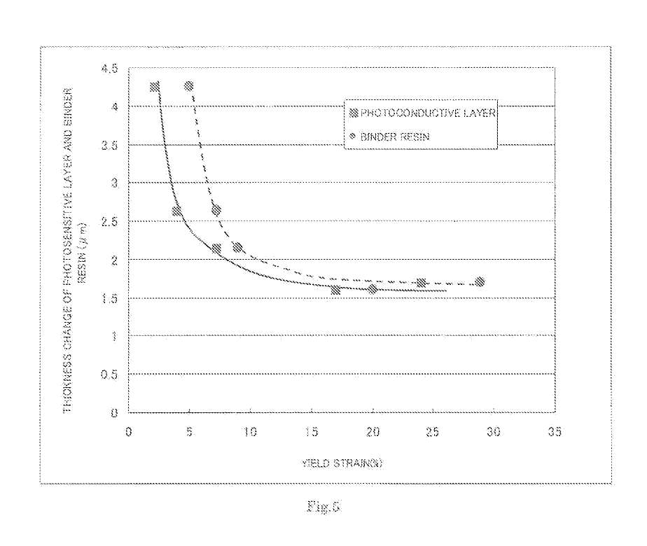

The relationship between the yield strain and the thickness change of the photosensitive layer and a binder resin of the multilayer electrophotographic photoconductor is plotted in graph form on the basis of data obtained in Examples 4 to 6 and Comparative Examples 4 and 5 and is illustrated in FIG. 5.

FIG. 5 demonstrates that a yield strain of the photosensitive layer, which is the outermost layer of the multilayer electrophotographic photoconductor, of less than about 5% results in a significant increase in the amount of thickness change and that a yield strain of the binder resin of less than about 8% results in a significant increase in the amount of thickness change.

The results of Examples 4 to 6 demonstrate that a yield strain of the charge-transport layer of about 5% to about 25% or a yield strain of the binder resin of about 8% to about 30% results in the multilayer electrophotographic photoconductor which exhibits only a small amount of thickness change and which has excellent wear resistance.

In the multilayer electrophotographic photoconductor produced in each of Comparative Examples 4 and 5 in which the photosensitive layers each had a yield strain of less than about 5% and in which the binder resins each had a yield strain of less than about 8%, the amount of thickness change was large. So, the photoconductor had poor wear resistance.

Having thus described in detail embodiments of the present invention, it is to be understood that the subject matter disclosed by the foregoing paragraphs is not to be limited to particular details and/or embodiments set forth in the above description. For example, particular numerical values or ranges are provided by way of illustration for clarity of exposition, and are not intended to limit the possible values or ranges that may be implemented in accordance with the present disclosure. Accordingly, it is understood that many variations of the embodiments and subject matter disclosed herein are possible without departing from the spirit or scope of the present disclosure.

What is claimed is:

1. An electrophotographic photoconductor comprising:
a photosensitive layer on a conductive base,
wherein
1) the photosensitive layer includes
a charge-generating layer including a charge-generating material, and
a charge-transport layer including a charge-transport material and a binder resin, the charge-generating layer and the charge-transport layer being stacked, in that order, on the conductive base, and the charge-transport layer having a yield strain of about 5% to about 25%, or
2) the photosensitive layer includes the charge-generating material, the charge-transport material, and the binder resin in the same layer and has a yield strain of about 5% to about 25%,
wherein the yield strain is measured using a 10 mm×30 mm rectangular sample having a thickness of 30 μm with both 10-mm sides held at an initial load of 1 N, a strain rate of 0.5 %/min, and a temperature of 30° C.,
wherein the electrophotographic photoconductor is configured for use as an image-bearing member of an image-forming apparatus that includes:
a charging portion configured to charge a surface of the image-bearing member
an exposure portion configured to expose the charged surface of the image-bearing member to form an electrostatic latent image on the surface of the image-bearing member,
a developing portion configured to develop the electrostatic latent image to form a toner image, and
a transfer portion configured to transfer the toner image from the image-bearing member to an object.

2. The electrophotographic photoconductor according to claim 1,
wherein the binder resin includes a polyester elastomer or a polyether elastomer.

3. The electrophotographic photoconductor according to claim 1,
wherein the proportion of the charge-transport layer is in the range of 10 parts by mass to 55 parts by mass with respect to 100 parts by mass of the binder resin.

4. The electrophotographic photoconductor according to claim 1,
wherein the charging portion includes a charging roller configured to come into contact with a surface of the electrophotographic photoconductor to charge the surface of the electrophotographic photoconductor.

5. The electrophotographic photoconductor according to claim 4,
wherein the charging portion applies only a direct voltage to the charging roller.

6. An electrophotographic photoconductor comprising:
a photosensitive layer on a conductive base,
wherein
1) the photosensitive layer includes
a charge-generating layer including a charge-generating material, and
a charge-transport layer including a charge-transport material and a binder resin, the charge-generating layer and the charge-transport layer being stacked, in that order, on the conductive base, and the binder resin in the photosensitive layer having a yield strain of about 8% to about 30%, or
2) the photosensitive layer includes the charge-generating material, the charge-transport material, and the binder resin in the same layer, the binder resin haying a yield strain of about 8% to about 30%,
wherein the yield strain is measured using a 10 mm×30 mm rectangular sample having a thickness of 30 μm with both 10-mm sides held at an initial load of 1 N, a strain rate of 0.5%/min, and a temperature of 30° C.,
wherein the electrophotographic photoconductor is configured for use as image-bearing member of an image-forming apparatus that includes:
a charging portion configured to charge a surface of the image-bearing member,
an exposure portion configured to expose the charged surface of the image-bearing member to form an electrostatic latent image on the surface of the image-bearing member,
a developing portion configured to develop the electrostatic latent image to form a toner image, and
a transfer portion configured to transfer the toner image from the image-bearing member to an object.

7. The electrophotographic photoconductor according to claim 6,
wherein the binder resin is a polycarbonate resin.

8. An image-forming apparatus comprising:
an image-bearing member;
a charging portion configured to charge a surface of the image-bearing member by a contact charging method;
an exposure portion configured to expose the charged surface of the image-bearing member to form an electrostatic latent image on the surface of the image-bearing member;
a developing portion configured to develop the electrostatic latent image to form a toner image; and
a transfer portion configured to transfer the toner image from the image-bearing member to an object,
wherein the image-bearing member is the electrophotographic photoconductor according to claim 1.

9. The image-forming apparatus according to claim 8,
wherein the charging portion includes a charging roller configured to come into contact with a surface of the electrophotographic photoconductor to charge the surface of the electrophotographic photoconductor.

10. The image-forming apparatus according to claim 9,
wherein the charging portion applies only a direct voltage to the charging roller.

11. The image-forming apparatus according to claim 10,
wherein the direct voltage applied to the charging roller is in the range of 1000 V to 2000 V.

12. The image-forming apparatus according to claim 9,
wherein the charging roller includes a resin layer composed of a resin, and
wherein the resin includes at least one of silicone resins, urethane resins; and silicone-modified resins.

13. The electrophotographic photoconductor according to claim 1, wherein the charging portion is configured to charge a surface of the image-bearing member by a contact charging method.

14. The electrophotographic photoconductor according to claim 6, wherein the charging portion is configured to charge a surface of the image-bearing member by a contact charging method.
